(19) United States
(12) Patent Application Publication
(10) Pub. No.: US 2004/0184119 A1
(43) Pub. Date: Sep. 23, 2004

(54) Imaging head unit, imaging device and imaging method

(75) Inventors: Daisuke Nakaya, Kanagawa (JP); Takeshi Fujii, Kanagawa (JP); Katsuto Sumi, Kanagawa (JP); Takao Ozaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/767,168

(22) Filed: Jan. 30, 2004

(30) Foreign Application Priority Data
Jan. 31, 2003 (JP) 2003-23089

(51) Int. Cl. H04N 1/04; H04N 1/46

(52) U.S. Cl. 358/497; 358/514

(57) ABSTRACT

An imaging head unit, imaging device and imaging method capable of eliminating scaling differences in a scanning direction of a plurality of imaging heads, and capable of implementing a scale factor conversion over the whole of the scanning direction. A plurality of exposure heads are plurally disposed along at least a direction intersecting the scanning direction to structure an imaging head unit. Update timings of pixels are altered for individual exposure heads, and thus the scaling differences between the exposure heads in the scanning direction are corrected.

### CROSS-REFERENCE TO RELATED APPLICATION

This application claims priority under 35 USC 119 from Japanese Patent Application No. 2003-23089, the disclosure of which is incorporated by reference herein.

### BACKGROUND OF THE INVENTION

1. Field of the Invention

The present invention relates to an imaging head unit, an imaging device and an imaging method, and particularly to an imaging head unit which moves, relative to a respective imaging surface, in a predetermined direction along the imaging surface, an imaging device which is equipped with this imaging head unit, and an imaging method which employs this imaging head unit.

2. Description of the Related Art

Heretofore, as an example of imaging devices, various exposure apparatuses are known which employ spatial light modulation elements (imaging elements), such as digital micromirror devices (DMD) or the like, for implementing image exposure with light beams modulated in accordance with image data. A DMD is a mirror device in which numerous micromirrors, which alter angles of reflection surfaces thereof in accordance with control signals, are arranged in a two-dimensional arrangement of L columns by M rows on a semiconductor support of silicon or the like. Practical exposure can be implemented by scanning the DMD in a certain direction along an exposure surface.

Ordinarily, the micromirrors of a DMD are arranged such that directions of alignment of the respective columns intersect with directions of alignment of the respective rows. By disposing such a DMD to be inclined with respect to the scanning direction, a spacing of scanning lines at a time of scanning can be made smaller, and resolution can be raised. For example, Japanese National Publication No. 2001-521672 (the published Japanese translation of PCT International Publication for Patent Application No. P2001-52672A) discloses that, in an illumination system which guides light toward sub-regions (spatial light modulation elements) which are equipped with a plurality of light valves, resolution can be raised by inclining these sub-regions with respect to projections thereof onto scanning lines.

Further, in the specification of U.S. patent Publication No. US-2002-0092993-A1, a scaling process is disclosed which corrects a scale factor error in a direction intersecting the scanning direction by rotating a pixel plane, which is for generating pixels, and implements a scale factor conversion in the scanning direction by altering the scanning speed.

In practice, a “line head” may be structured by lining up a plurality of imaging heads, which utilize imaging elements, in a direction intersecting a scanning direction. At such a line head, in a case in which there are scale factor differences between the imaging heads, the scanning speed can be altered for individual heads. Consequently, the scale factor differences can be eliminated.

### SUMMARY OF THE INVENTION

In consideration of the circumstances described above, an object of the present invention is to provide an imaging head unit, imaging device and imaging method capable of correcting for scale factor differences of a plurality of imaging heads in a scanning direction, and capable of implementing a scale factor conversion over the scanning direction as a whole.

In order to achieve the object described above, a first aspect of the present invention is an imaging head unit including a plurality of imaging heads arranged along at least a direction intersecting a predetermined scanning direction, the imaging heads moving, relative to a respective imaging surface in the scanning direction along the imaging surface, and pixel update timings of the imaging heads being alterable in at least the scanning direction for individual the imaging heads.

With this imaging head unit, the imaging heads are relatively moved in the predetermined scanning direction along the scanning surface, and imaging (image recording) is carried out at the imaging surface by the respective imaging heads.

Pixel update timings in at least the scanning direction can be altered for each imaging head. Accordingly, pixel update timings can similarly be altered for all of the imaging heads. Thus, a scale factor conversion in the scanning direction can be implemented.

Furthermore, it is possible to update pixels with differing pixel update timings for each imaging head. Thus, even if there is a scale factor difference between the imaging heads, the scale factor difference can be eliminated by altering the pixel update timings accordingly.

It is possible for the alteration of a pixel update timing to be implemented by altering an imaging timing by a duration which is determined by a ratio between a spacing error of an imaging element in the scanning direction and a scanning speed (a second aspect of the present invention). Here, spacing errors between imaging elements may be calculated by, for example, specifying an imaging element to act as a reference and calculating on the basis of distances from this reference imaging element, and can be calculated from relative positions of the imaging elements.

According to a third aspect of the present invention, the imaging heads of the first or second aspect include a plurality of imaging elements which are two-dimensionally arranged in a plane which is substantially parallel to the imaging surface, and the imaging head is rotatable about a line perpendicular to the imaging surface.

Thus, by rotating the two-dimensionally arranged imaging elements, a spacing of pixels in the direction perpendicular to the scanning direction can be tightened, and resolution can be raised. Further, by adjusting the rotation angle, implementation of a scale factor conversion in the direction perpendicular to the scanning direction is enabled.

According to a fourth aspect of the present invention, in the first, second or third aspect, a scanning speed in the scanning direction is alterable.

Accordingly, implementation of a scale factor conversion in the scanning direction by altering the scanning speed is also enabled. That is, an alteration of scale in the scanning direction can be implemented by either or both of alteration of the pixel update timings in the scanning direction and alteration of the scanning speed.

As imaging heads structuring an imaging head unit of the present invention, inkjet recording heads which eject ink droplets at the imaging surface in accordance with image information may be used, or the imaging heads may be imaging heads that include modulated light irradiation devices which irradiate light, which is modulated at each of pixels in accordance with image information, at an exposure surface which includes the imaging surface (a fifth aspect of the present invention). In such an imaging head, the light that is modulated at each of the pixels in accordance with the image information is irradiated at the exposure surface, which is the imaging surface, from the modulated light irradiation device. Hence, a two-dimensional image is rendered at the exposure surface by relatively moving the imaging head unit, which is equipped with a plurality of these imaging heads, in a direction along the exposure surface with respect to the exposure surface.

As such a modulated light irradiation device, for example, a two-dimensional array light source, in which numerous point light sources are arrayed in a two-dimensional arrangement, can be used. At such a structure, the respective point light sources emit light in accordance with the image information. This light is guided, as necessary, through a light-guiding member, such as a high-luminance fiber or the like, to a predetermined position. Further, as necessary, the light is subjected to adjustment by an optical system of lenses, mirrors and the like, and is irradiated at the exposure surface.

Further, the modulated light irradiation apparatus may be structured to include: a laser device which irradiates laser light; a spatial light modulation element at which numerous imaging element portions, which respectively alter light modulation states in accordance with control signals, are arranged in a two-dimensional arrangement, the spatial light modulation element modulating the laser light irradiated from the laser device; and a control section which controls the imaging element portions by the control signals, which are generated in accordance with the image information (a sixth aspect of the present invention). With this structure, the light modulation states of the respective imaging element portions of the spatial light modulation element are changed by the control section, and the laser light irradiated at the spatial light modulation element is modulated and irradiated at the exposure surface. Of course, as necessary, light-guiding members such as high-luminance fibers or the like, an optical system of lenses, mirrors and the like, and the like may be utilized.

A micromirror device which includes numerous micromirrors arranged in a two-dimensional arrangement, angles of reflection surfaces of which micromirrors are respectively alterable in accordance with the control signals, (a seventh aspect of the present invention) or a liquid crystal shutter array which includes numerous liquid crystal cells arranged in a two-dimensional arrangement, which are respectively capable of blocking transmitted light in accordance with the control signals, (an eighth aspect of the present invention) may be employed as the spatial light modulation element.

An image device of a ninth aspect of the present invention includes: an imaging head unit of any of the first to eighth aspects; and a movement apparatus which relatively moves the imaging head unit in at least the scanning direction.

Accordingly, processing for exposure, ink discharge or the like by the imaging head unit at the imaging surface is implemented while the imaging head unit moves relative to the imaging surface, and carries out imaging on the imaging surface. Because this imaging device includes the imaging head unit of any of the first to eighth aspects, a scale factor conversion in the scanning direction can be implemented, in addition to which scale factor differences can be eliminated.

An imaging method of a tenth aspect of the present invention employs an imaging head unit of any of the first to eighth aspects, and includes steps of: relatively moving an imaging unit, which includes the imaging head unit, along the imaging surface in the predetermined scanning direction for imaging; altering pixel update timings for individual the imaging head units in accordance with a scale factor difference; and implementing a conversion of an imaging scale factor in at least the scanning direction.

Accordingly, while the imaging head unit is relatively moved in the predetermined scanning direction along the scanning surface, imaging is carried out at the imaging surface by the plurality of imaging heads structuring the imaging head unit. In this imaging process, because an imaging head unit of any of the first to eighth aspects is employed, a scale factor conversion in the scanning direction can be implemented, in addition to which scale factor differences can be eliminated.

### BRIEF DESCRIPTION OF THE DRAWINGS

FIG. 1 is a perspective view showing external appearance of an exposure device of a first embodiment of the present invention.

FIG. 2 is a perspective view showing structure of a scanner of the exposure device of the first embodiment of the present invention.

FIG. 3A is a plan view showing exposed regions formed at a photosensitive material.

FIG. 3B is a view showing an arrangement of exposure areas due to respective exposure heads.

FIG. 4 is a perspective view showing general structure of an exposure head of the first embodiment of the present invention.

FIG. 5A is a sectional view, cut in a sub-scanning direction along an optical axis, which shows structure of the exposure head shown in FIG. 4.

FIG. 5B is a side view of FIG. 5A.

FIG. 6 is a partial enlarged view showing structure of a digital micromirror device (DMD) relating to the exposure head of the first embodiment of the present invention.

FIGS. 7A and 7B are explanatory views for explaining operation of the DMD relating to the exposure head of the first embodiment of the present invention.

FIG. 8 is an explanatory view showing positions and row pitch of exposure beams from a DMD which is inclinedly disposed in the exposure head of the first embodiment of the present invention.

FIG. 9 is an explanatory view showing a case in which overlapping of scanning directions of the exposure beams from the DMD which is inclinedly disposed occurs at the exposure head of the first embodiment of the present invention.

FIG. 10A is a perspective view showing structure of a fiber array light source.

FIG. 10B is a partial enlarged view of FIG. 10A.

FIG. 10C is a plan view showing an arrangement of light emission points at a laser emission portion.

FIG. 10D is a plan view showing another arrangement of light emission points at a laser emission portion.

FIG. 11 is a plan view showing structure of a multiplex laser light source relating to the first embodiment of the present invention.

FIG. 12 is a plan view showing structure of a laser module relating to the first embodiment of the present invention.

FIG. 13 is a side view showing structure of the laser module shown in FIG. 12.

FIG. 14 is a partial elevational view showing structure of the laser module shown in FIG. 12.

FIG. 15 is a graph showing a relationship between time and scanning position in a case in which scanning speed is altered to implement a scale factor conversion in a scanning direction.

FIG. 16A is a graph showing a relationship between time and scanning position in a case in which data update timing is altered to implement a scale factor conversion in the scanning direction.

FIG. 16B is another graph showing the relationship between time and scanning position in the case in which data update timing is altered to implement a scale factor conversion in the scanning direction.

FIG. 17 is an explanatory view showing a case, at the exposure head of the first embodiment of the present invention, in which differences in positions of scanning directions of the exposure beams arise in accordance with the DMD that is inclinedly disposed.

FIG. 18 is a graph showing a relationship, at the exposure head of the first embodiment of the present invention, between time and scanning position in a case in which the differences in positions of scanning directions of the exposure beams according to the DMD that is inclinedly disposed are to be eliminated.

FIG. 19 is a plan view for explaining an exposure technique which exposes a photosensitive material with a single cycle of scanning by a scanner.

FIG. 20A is a plan view for explaining an exposure technique which exposes a photosensitive material with a plurality of cycles of scanning by a scanner.

FIG. 20B is a plan view for explaining the exposure technique which exposes a photosensitive material with a plurality of cycles of scanning by a scanner.

### DETAILED DESCRIPTION OF THE INVENTION

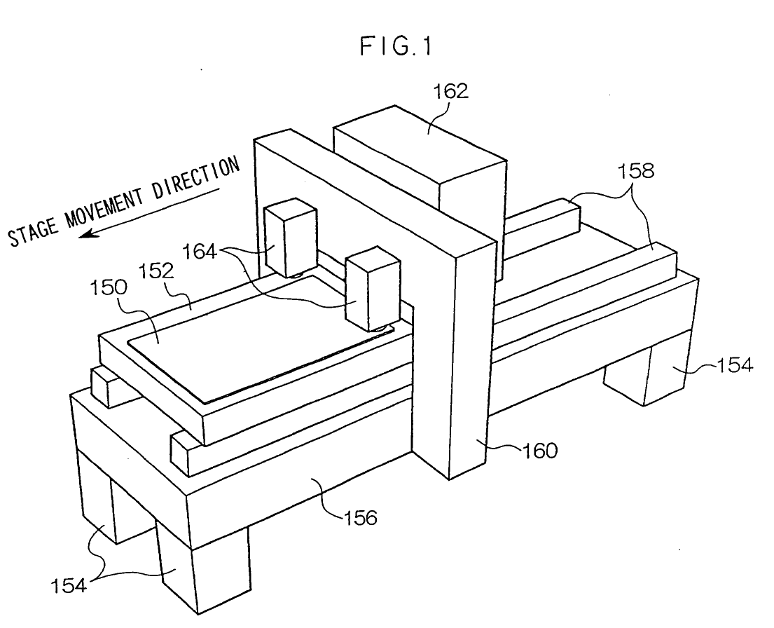

An imaging device relating to an embodiment of the present invention is a “flatbed”-type exposure apparatus. As shown in FIG. 1, the imaging device is provided with a flat board-form stage 152, which adsorbs and retains a sheet-form photosensitive material 150 at a surface thereof. Two guides 158, which extend in a stage movement direction, are provided at an upper face of a thick board-form equipment platform 156, which is supported by four leg portions 154. The stage 152 is disposed such that a longitudinal direction thereof is oriented in the stage movement direction, and is supported by the guides 158 so as to be movable backward and forward. At this exposure apparatus, an unillustrated driving apparatus is provided for driving the stage 152 along the guides 158. As described later, the driving apparatus is controlled by an unillustrated controller such that a movement speed (a scanning speed) of the stage 152 corresponds to a desired scale factor in the scanning direction.

At a central portion of the equipment platform 156, an ‘n’-like gate 160 is provided so as to straddle a movement path of the stage 152. Respective end portions of the ‘n’-like gate 160 are fixed at two side faces of the equipment platform 156. Sandwiching the gate 160, a scanner 162 is provided at one side, and a plurality (for example, two) of detection sensors 164 are provided at the other side. The detection sensors 164 detect a leading end and a trailing end of the photosensitive material 150. The scanner 162 and the detection sensors 164 are respectively mounted at the gate 160, and are fixedly disposed upward of the movement path of the stage 152. The scanner 162 and detection sensors 164 are connected to an unillustrated controller, which controls the scanner 162 and detection sensors 164. As described later, the scanner 162 and detection sensors 164 are controlled such that, at a time of exposure by exposure heads 166, the exposure heads 166 expose with predetermined timings.

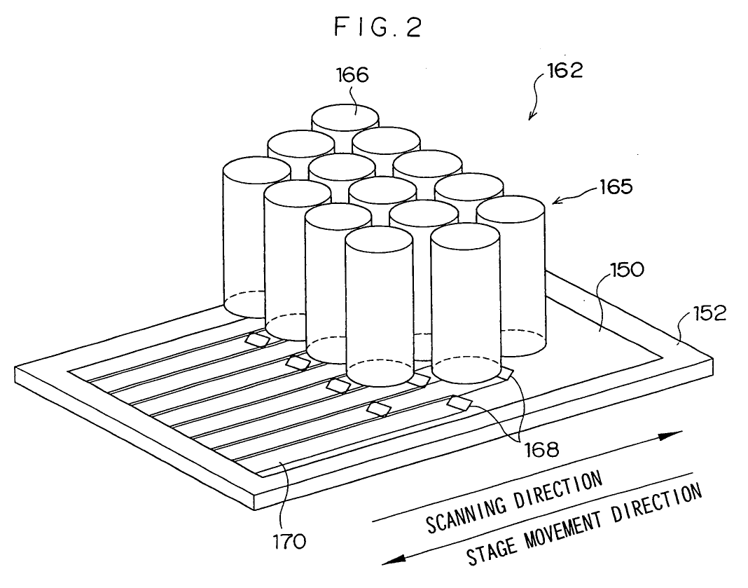

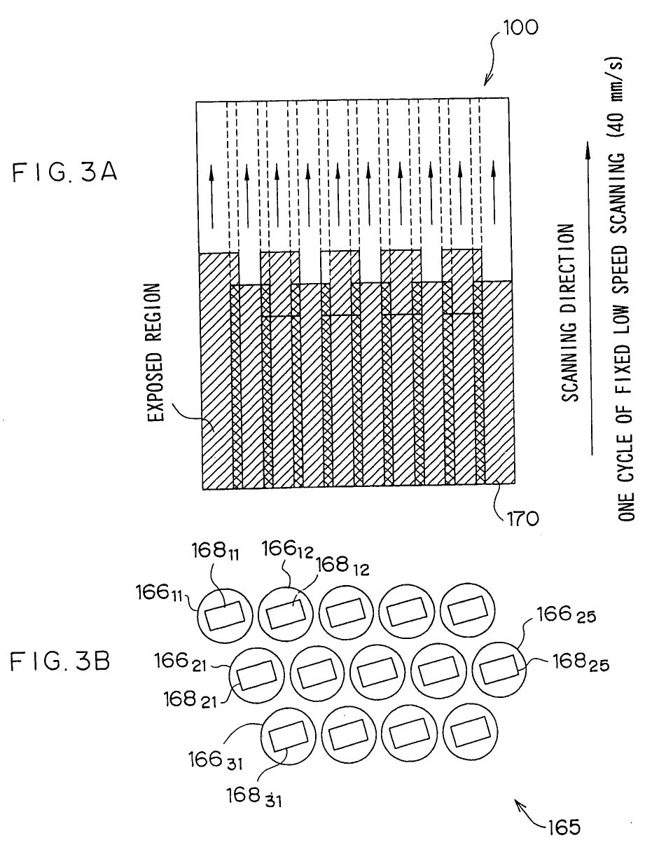

As shown in FIGS. 2 and 3B, the scanner 162 is equipped with a plurality of the exposure heads 166, which are arranged substantially in a matrix pattern with m rows and n columns (for example, three rows and five columns). Such pluralities of the exposure heads 166 are plurally arranged to structure an exposure head unit 165. In particular, in the present embodiment, pluralities of the exposure heads 166 are arranged in at least a direction intersecting the scanning direction (below, the direction intersecting the scanning direction is referred to as a “head arrangement direction”). In this example, in consideration of width of the photosensitive material 150, five of the exposure heads 166 are provided in each of the first and second rows, four of the exposure heads 166 are provided in the third row, and there are fourteen exposure heads 166 in total. Note that when an individual exposure head which is arranged in an m-th row and an n-th column is to be referred to, that exposure head is denoted as exposure head 166ₘₙ.

Exposure areas 168 covered by the exposure heads 166 have rectangular shapes with short sides thereof in a sub-scanning direction, as in FIG. 2, and are inclined at a predetermined inclination angle with respect to the head arrangement direction. Hence, in accordance with movement of the stage 152, band-form exposed regions 170 are formed on the photosensitive material 150 at the respective exposure heads 166. Note that when an exposure area corresponding to an individual exposure head which is arranged in an m-th row and an n-th column is to be referred to, that exposure area is denoted as exposure area 168ₘₙ.

As shown in FIGS. 3A and 3B, in each row, the respective exposure heads, which are arranged in a line, are disposed to be offset by a predetermined interval in the head arrangement direction such that the band-form exposed regions 170 partially overlap with respective neighboring the exposed regions 170. Thus, a portion between the exposure area 168₁₁ and the exposure area 168₁₂ of the first row is exposed by the exposure area 168₂₁ of the second row and the exposure area 168₃₁ of the third row.

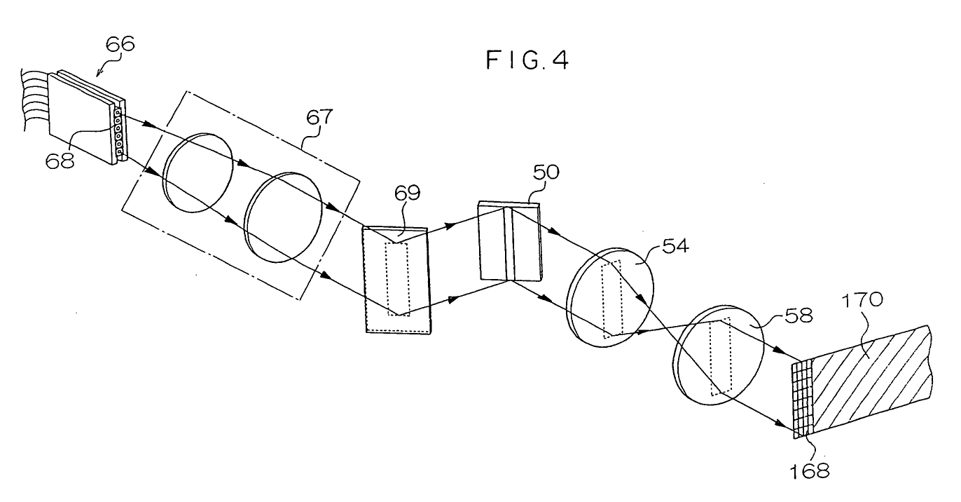

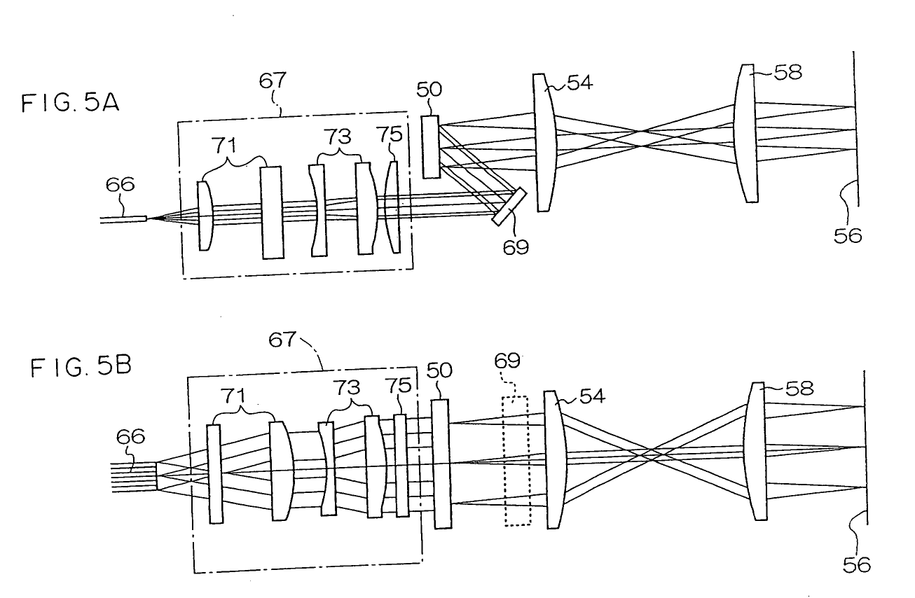

As shown in FIGS. 4, 5A and 5B, at each of the exposure heads 166₁₁ to 166ₘₙ, a digital micromirror device (DMD) 50 is provided to serve as a spatial light modulation element for modulating an incident light beam at each of pixels in accordance with image data. The DMD 50 is connected with an unillustrated controller, which is provided with a data processing section and a mirror driving control section. At the data processing section of this controller, on the basis of inputted image data, control signals are generated for driving control of each micromirror in a region of the DMD 50 at the corresponding exposure head 166 which region is to be controlled. Herein, the controller includes an image data conversion function for making resolution in a row direction higher than in an original image. By raising the resolution in this manner, various processes and corrections of the image data can be implemented with higher accuracy. For example, in a case in which a number of pixels employed is altered in accordance with an inclination angle of the DMD 50 and a row pitch is corrected, correction with higher accuracy is enabled. This conversion of the image data enables conversions which include magnification or reduction of the image data.

The mirror driving control section controls the angle of a reflection surface of each micromirror of the DMD 50 at the corresponding exposure head 166 on the basis of the control signals generated at the image data processing section.

A fiber array light source 66, a lens system 67 and a mirror 69 are disposed in this order at a light incidence side of the DMD 50. The fiber array light source 66 is equipped with a laser emission portion at which emission end portions (light emission points) of optical fibers are arranged in a row along a direction corresponding to the direction of the long sides of the exposure area 168. The lens system 67 corrects laser light that is emitted from the fiber array light source 66, and focuses the light on the DMD 50. The mirror 69 reflects the laser light that has been transmitted through the lens system 67 toward the DMD 50.

The lens system 67 is structured with a single pair of combination lenses 71, which make the laser light that has been emitted from the fiber array light source 66 parallel, a single pair of combination lenses 73, which correct the laser light that has been made parallel such that a light amount distribution is more uniform, and a condensing lens 75 which focuses the laser light whose light amount distribution has been corrected onto the DMD. The combination lenses 73 have functions of, in the direction of arrangement of the laser emission ends, broadening portions of light flux that are close to an optical axis of the lenses and constricting portions of the light flux that are distant from the optical axis, and in a direction intersecting this direction of arrangement, transmitting the light unaltered. Thus, the laser light is corrected such that the light amount distribution is uniform.

Lens systems 54 and 58 are disposed at a light reflection side of the DMD 50. The lens systems 54 and 58 focus the laser light that has been reflected at the DMD 50 on a scanning surface (a surface that is to be exposed) 56 of the photosensitive material 150. The lens systems 54 and 58 are disposed such that the DMD 50 and the surface to be exposed 56 have a conjugative relationship.

The present embodiment is specified such that, after the laser light emitted from the fiber array light source 66 has broadened substantially by a factor of five, the laser light is constricted to approximately 5 mm for each pixel by these lens systems 54 and 58.

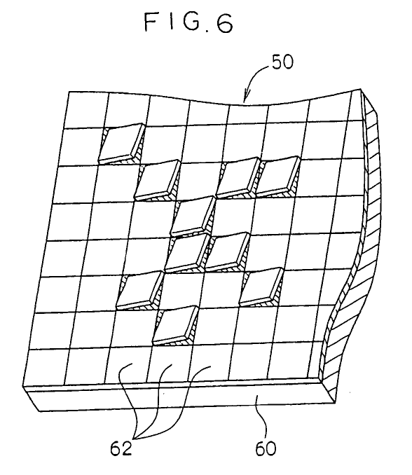

As shown in FIG. 6, at the DMD 50, very small mirrors (micromirrors) 62, which are supported by support columns, are disposed on an SRAM cell (memory cell) 60. The DMD 50 is a mirror device which is structured with a large number (for example, 1024 by 768, with a pitch of 13.68 μm) of these extremely small mirrors, which structure image elements (pixels), arranged in a checkerboard pattern. At each pixel, the micromirror 62 is provided so as to be supported at an uppermost portion of the support column. A material with high reflectivity, such as aluminium or the like, is applied by vapor deposition at a surface of the micromirror 62. Here, the reflectivity of the micromirror 62 is at least 90%. The SRAM cell 60 with CMOS silicon gates, which is fabricated by a continuous semiconductor memory production line, is disposed directly under the micromirror 62, with the support column, which includes a hinge and a yoke, interposed therebetween. The whole of this structure is monolithic (an integrated form).

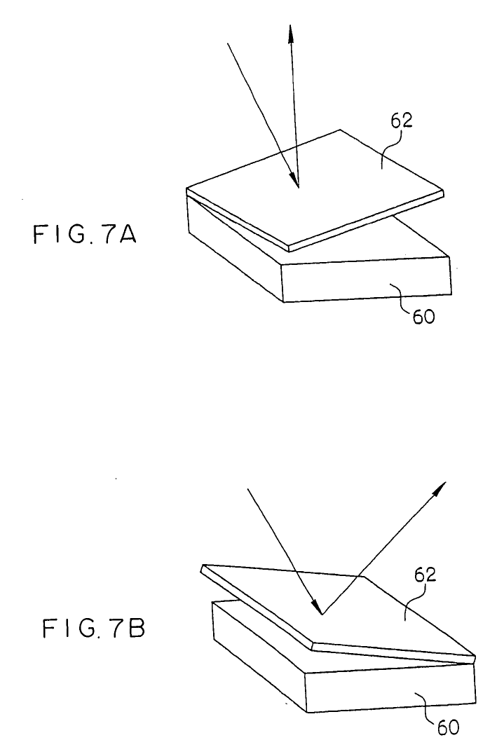

When digital signals are written to the SRAM cell 60 of the DMD 50, the micromirrors 62 supported at the support columns are inclined, about a diagonal, within a range of ±α° (for example, ±10°) relative to the side of a support on which the DMD 50 is disposed. FIG. 7A shows a state in which the micromirror 62 is inclined at ±α°, which is an ‘ON’ state, and FIG. 7B shows a state in which the micromirror 62 is inclined at −α°, which is an ‘OFF’ state. Accordingly, as a result of control of the inclinations of the micromirrors 62 at the pixels of the DMD 50 in accordance with image signals, as shown in FIG. 6, light that is incident at the DMD 50 is reflected in directions of inclination of the respective micromirrors 62.

FIG. 6 shows a portion of the DMD 50 enlarged, and shows an example of a state in which the micromirrors 62 are controlled to +α° and −α°. The ON-OFF control of the respective micromirrors 62 is carried out by the unillustrated controller connected to the DMD 50. A light-absorbing body (which is not shown) is disposed in the direction in which light beams are reflected by the micromirrors 62 that are in the OFF state.

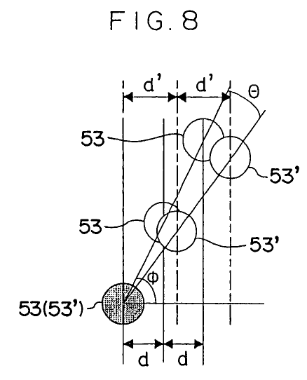

FIG. 8 shows an arbitrary example of a row of images (pixels) of exposure beams from the exposure area 168, of which row a portion corresponding to three pixels is taken. The exposure area 168 is inclined at a predetermined inclination angle φ (or φ-θ), which is measured from the direction intersecting the scanning direction. Thus, by inclinedly disposing the DMD 50 such that the exposure area 168 is inclined at the predetermined inclination angle, a row pitch d of scanning tracks (scanning lines) of exposure beams 53 from the micromirrors is smaller (approximately 0.27 μm in the present embodiment), and is narrower than a row pitch of scanning lines in a case in which the exposure area 168 is not inclined, and than a resolution of the image data itself (2 μm). Consequently, resolution can be raised.

Hence, as can be seen from FIG. 8, in the present embodiment the above-mentioned row pitch can be altered from d to d′, such that a scale factor can be converted, by further rotating the inclination angle φ by an angle θ. In the example shown in FIG. 8, the inclination angle is further rotated from the original inclination angle φ to set the inclination angle to φ-θ. Hereafter, exposure beam images (pixels) before rotation (at the inclination angle φ) are indicated by the reference numeral 53, and exposure beam images (pixels) after rotation (at the inclination angle φ-θ) are indicated by the reference numeral 53′. The row pitch d′ after rotation becomes:

d′=d×cos(φ-θ)/cosφ (equation 1)

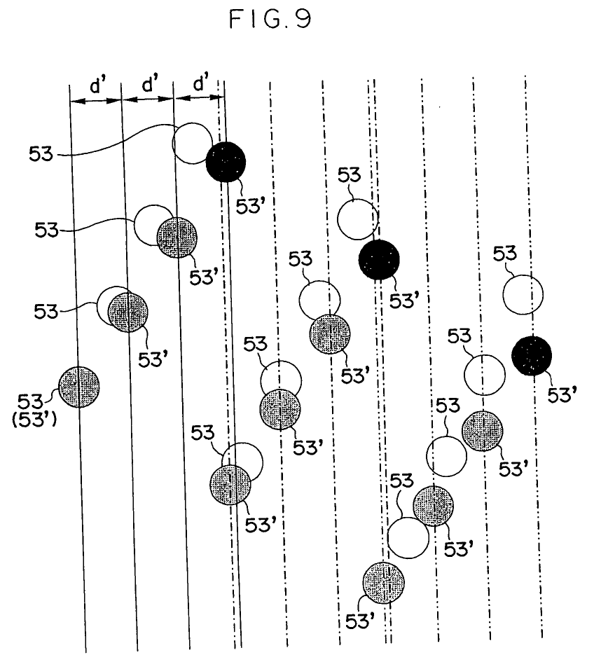

FIG. 9 shows exposure beam images (pixels) when the DMD 50 has been rotated thus, of which four pixels in the scanning direction and three pixels in the head arrangement direction are taken. As can be seen from FIG. 9, the uppermost exposure beam 53′ of a left row (shown by a black circle) may overlap with the lowermost exposure beam 53′ of a next row, as viewed from the scanning direction. In such a case, the number of pixels employed in each row can be changed such that the row pitch of the exposure beams 53′ is close to the proper row pitch after rotation d′. In the example illustrated in FIG. 9, the exposure beams 53′ shown by black circles are set to not be employed. Thus, three pixels in the row direction are employed after rotation, in comparison to four pixels being employed before rotation. Further, in a case in which the rotation angle of the DMD 50 is rotated in the other way, gaps may be formed between the exposure beams 53′. It is possible to eliminate such gaps by, in consideration of such cases, providing a larger number of pixels in the row direction beforehand to provide an excess thereof, and hence increasing the number of pixels employed in the row direction.

Now, if, for example, a certain sample image is recorded and such alterations of the number of pixels employed are carried out such that variations in the row pitch that are found from results of inspection of the sample image are eliminated, the number of pixels employed can be set to a suitable number at low cost. Of course, if it is possible to accurately measure the actual inclination angle, the number of pixels employed may be determined on the basis of results of such measurement.

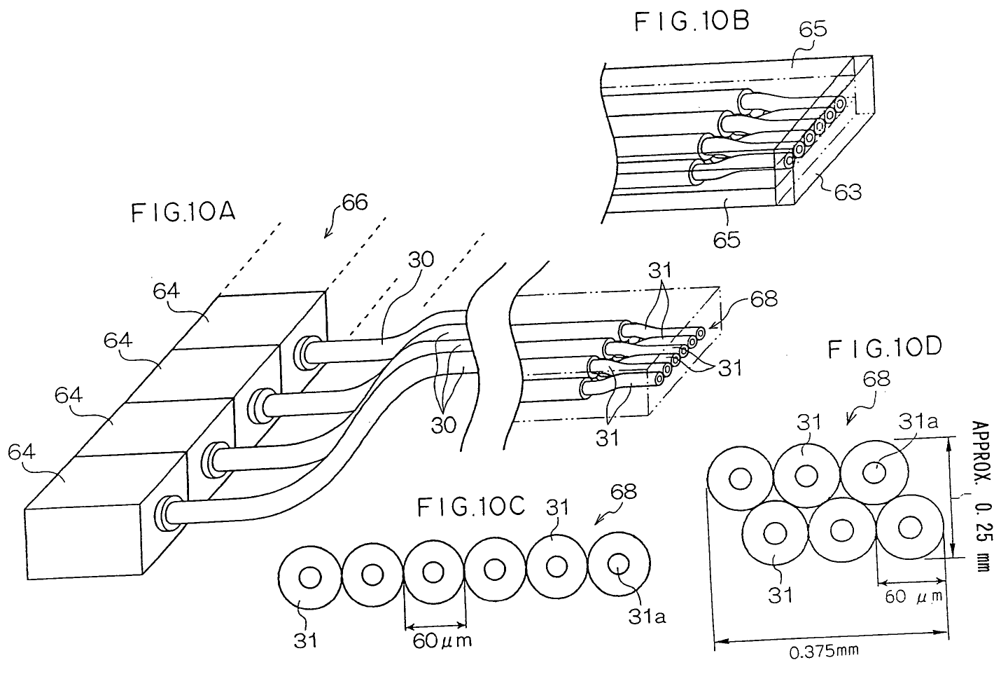

FIG. 10A shows structure of the fiber array light source 66. The fiber array light source 66 is equipped with a plurality (for example, six) of laser modules 64. At each of the laser modules 64, one end of a multi-mode optical fiber 30 is connected. At the other end of the multi-mode optical fiber 30, an optical fiber 31, whose core diameter is the same as that of the multi-mode optical fiber 30 and whose cladding diameter is smaller than that of the multi-mode optical fiber 30, is connected. As shown in FIG. 10C, emission end portions (light emission points) of the multi-mode optical fibers 31 are arranged in a single row along a main scanning direction, which intersects the sub-scanning direction, to structure a laser emission portion 68. Note that the light emission points may be arranged in two rows along the main scanning direction, as shown in FIG. 10D.

As is shown in FIG. 10B, the emission end portions of the optical fibers 31 are interposed and fixed between two support plates 65, which have flat faces. Furthermore, a transparent protective plate 63, of glass or the like, is disposed at the light emission side of the optical fibers 31 in order to protect end faces of the optical fibers 31. The protective plate 63 may be disposed to be closely contacted with the end faces of the optical fibers 31, and may be disposed such that the end faces of the optical fibers 31 are sealed. The emission end portions of the optical fibers 31 have high optical density, tend to attract dust, and are susceptible to deterioration. However, by disposing the protective plate 63 thus, adherence of dust to the end faces can be prevented and deterioration can be slowed.

As the multi-mode optical fibers 30 and the optical fibers 31, any of step index-type optical fibers, graded index-type optical fibers and multiplex-type optical fibers can be used. For example, a step index-type optical fiber produced by Mitsubishi Cable Industries, Ltd. could be used.

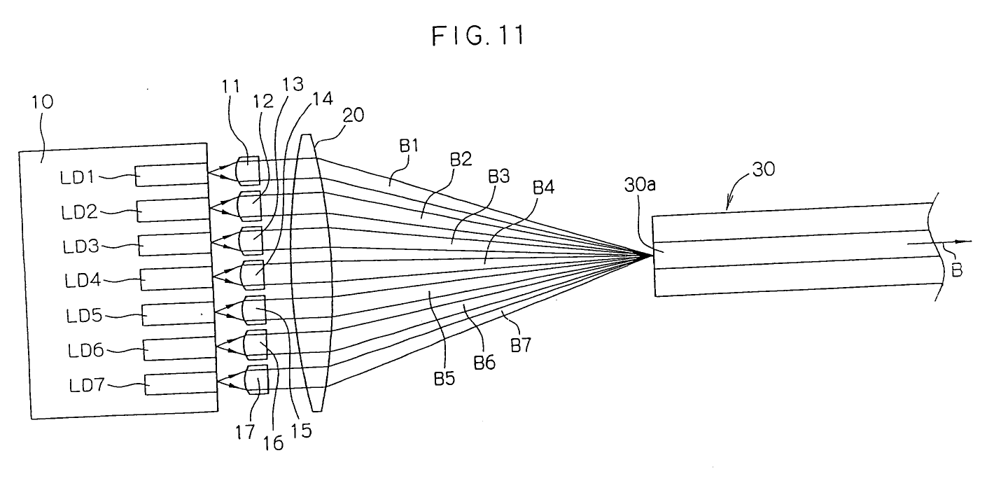

The laser module 64 is structured by a multiplexed laser light source (fiber light source) shown in FIG. 11. This multiplex laser light source is structured with a plurality (for example, seven) of chip-form lateral multi-mode or single-mode GaN-based semiconductor lasers LD1, LD2, LD3, LD4, LD5, LD6 and LD7, collimator lenses 11, 12, 13, 14, 15,16 and 17, a single condensing lens 20, and one of the multi-mode optical fibers 30. The GaN-based semiconductor lasers LD1 to LD7 are fixedly arranged on a heat block 10. The collimator lenses 11 to 17 are provided in correspondence with the GaN-based semiconductor lasers LD1 to LD7, respectively. Note that the number of semiconductor lasers is not limited to seven.

The GaN-based semiconductor lasers LD1 to LD7 all have a common oscillation wavelength (for example, 405 nm), and a common maximum output (for example, 100 mW for multi-mode lasers, 30 mW for single-mode lasers). For the GaN-based semiconductor lasers LD1 to LD7, lasers can be utilized which are provided with an oscillation wavelength different from the above-mentioned 405 nm, in a wavelength range of 350 nm to 450 nm.

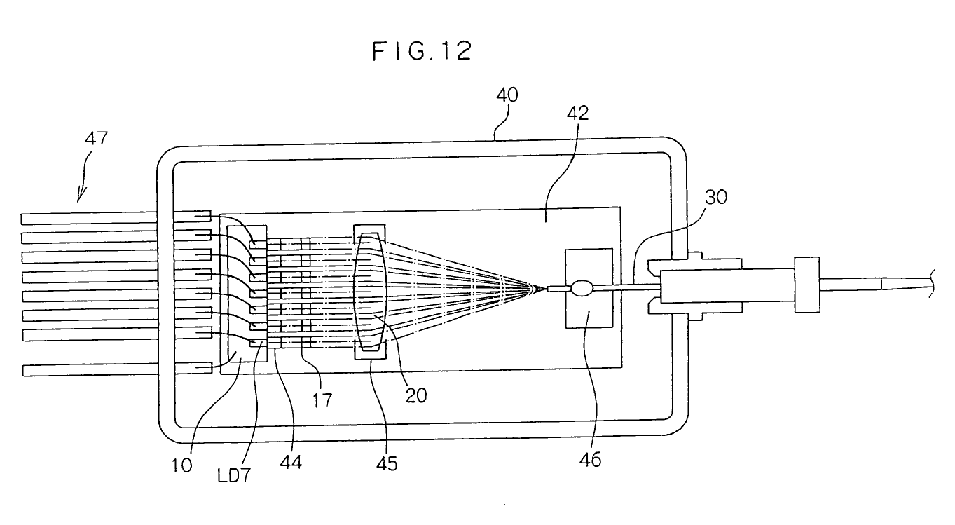

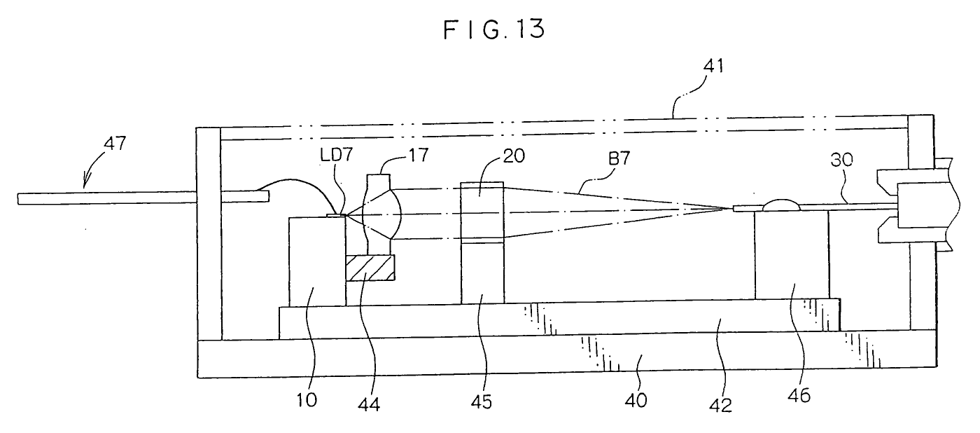

As shown in FIGS. 12 and 13, the above-described multiplex laser light source, together with other optical elements, is accommodated in a box-like package 40, which opens upward. The package 40 is provided with a package lid 41 prepared so as to close this opening of the package 40. After an air removal treatment, sealed gas is introduced and the opening of the package 40 is closed by the package lid 41. Thus, the above-described multiplex laser light source is hermetically sealed in a closed space (sealed space) formed by the package 40 and the package lid 41.

A baseplate 42 is fixed at a lower face of the package 40. The heat block 10, a condensing lens holder 45 and a fiber holder 46 are attached at an upper face of the baseplate 42. The condensing lens holder 45 holds the condensing lens 20. The fiber holder 46 holds an incidence end portion of the multi-mode optical fiber 30. An opening is formed in a wall face of the package 40. The emission end portion of the multi-mode optical fiber 30 is led out through this opening to outside the package.

A collimator lens holder 44 is attached at a side face of the heat block 10, and holds the collimator lenses 11 to 17. Openings are formed in a lateral wall face of the package 40. Wiring 47, which supplies driving current to the GaN-based semiconductor lasers LD1 to LD7, is passed through these openings and led out to outside the package 40.

Note that in FIG. 13, in order to alleviate complexity of the drawing, of the plurality of GaN-based semiconductor lasers, only the GaN-based semiconductor laser LD7 is marked with a reference numeral, and of the plurality of collimator lenses, only the collimator lens 17 is marked with a reference numeral.

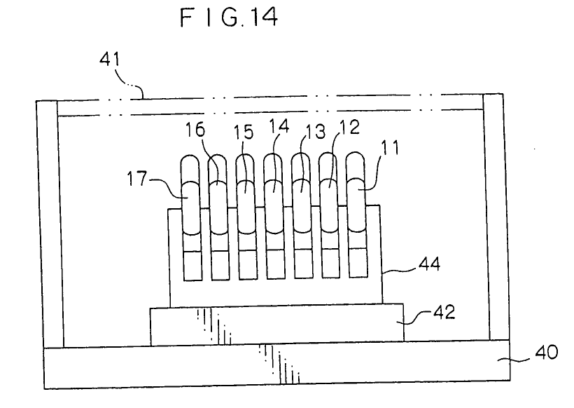

FIG. 14 shows mounting portions of the collimator lenses 11 to 17, as viewed from front faces thereof. Each of the collimator lenses 11 to 17 is formed in a long, narrow, cut-down shape with parallel flat faces defining a region that includes an optical axis of a circular-form lens which is provided with an aspherical surface. The collimator lenses with this long, narrow shape may be formed, for example, by molding-formation of resin or optical glass. The collimator lenses 11 to 17 are closely disposed in a direction of arrangement of light emission points of the GaN-based semiconductor lasers LD1 to LD7 (the left-right direction in FIG. 14) such that the length directions of the collimator lenses 11 to 17 cross the direction of arrangement of the light emission points.

As the GaN-based semiconductor lasers LD1 to LD7, lasers may be employed which are provided with an active layer with a light emission width of 2 μm, and which emit respective laser beams B1 to B7 in forms which widen at angles of, for example, 10° and 30° with respect, respectively, to a direction parallel to the active layers and a direction perpendicular to the active layers. These GaN-based semiconductor lasers LD1 to LD7 are disposed such that the light emission points are lined up in a single row in the direction parallel to the active layers.

Accordingly, the laser beams B1 to B7 emitted from the respective light emission points are incident, respectively, on the collimator lenses 11 to 17 having the long, narrow forms described above, in states in which the direction for which the spreading angle of the beam is greater coincides with the length direction of the lens and the direction in which the spreading angle is smaller coincides with a width direction (a direction intersecting the length direction).

The condensing lens 20 is cut away in a long, narrow shape with parallel flat faces defining a region that includes an optical axis of a circular-form lens which is provided with an aspherical surface, and is formed in a shape which is long in the direction of arrangement of the collimator lenses 11 to 17 (i.e., the horizontal direction) and short in a direction perpendicular thereto. A lens that has, for example, a focusing distance f₂=23 mm and NA=0.2 can be employed as the condensing lens 20. The condensing lens 20 is also formed by, for example, molding-formation of resin or optical glass.

Next, operation of the exposure device described above will be described.

At each of the exposure heads 166 of the scanner 162, the respective laser beams B1, B2, B3, B4, B5, B6 and B7, which are emitted in divergent forms from the respective GaN-based semiconductor lasers LD1 to LD7 that structure the multiplex laser light source of the fiber array light source 66, are converted to parallel light by the corresponding collimator lenses 11 to 17. The laser beams B 1 to B7 that have been collimated are focused by the condensing lens 20, and converge at the incidence end face of a core 30a of the multi-mode optical fiber 30.

In the present embodiment, a condensing optical system is structured by the collimator lenses 11 to 17 and the condensing lens 20, and a multiplexing optical system is structured by the condensing optical system and the multi-mode optical fiber 30. Thus, the laser beams B1 to B7 focused by the condensing lens 20 as described above enter the core 30a of the multi-mode optical fiber 30, are propagated in the optical fiber, multiplexed to a single laser beam B, coupled at the emission end portion of the multi-mode optical fiber 30, and emitted from the optical fiber 31.

At the laser emission portion 68 of the fiber array light source 66, high-luminance light emission points are arranged in a single row along the main scanning direction. Because a conventional fiber light source, in which laser light from a single semiconductor laser is focused at a single optical fiber, would have low output, a desired output could not be obtained without arranging these conventional light sources in a large number of rows. However, because the multiplex laser light sources employed in the present embodiment have high output, a desired output can be obtained with only a small number of rows, for example, one row.

Image data corresponding to an exposure pattern is inputted to an unillustrated controller which is connected to the DMDs 50, and is temporarily stored at a frame memory in the controller. This image data is data which represents a density of each pixel structuring an image with a binary value (whether or not a dot is to be recorded).

The stage 152, at which the surface of the photosensitive material 150 is adsorbed, is moved along the guides 158 at a constant speed by the unillustrated driving apparatus, from an upstream side of the gate 160 to a downstream side thereof. When the stage 152 is passing under the gate 160, and the leading end of the photosensitive material 150 has been detected by the detection sensors 164 mounted at the gate 160, the image data stored in the frame memory is read out as a plurality of line portion units in sequence, and control signals for each of the exposure heads 166 are generated on the basis of the image data read from the data processing section. Hence, the micromirrors of the DMDs 50 at the respective exposure heads 166 are respectively switched on and off by the mirror driving control section on the basis of the control signals that have been generated.

When laser light is irradiated from the fiber array light sources 66 to the DMDs 50, if a micromirror of the DMD 50 is in the ON state, the reflected laser light is focused on the surface to be exposed 56 of the photosensitive material 150 by the lens systems 54 and 58. Thus, the laser light irradiated from the fiber array light source 66 is turned on or off at each pixel, and the photosensitive material 150 is exposed in a unit (the exposure area 168) with a number of pixels substantially the same as a number of pixels employed at the DMD 50.

In the present embodiment, because the DMD 50 is inclinedly disposed, the exposure area 168 is inclined at the predetermined inclination angle with respect to the sub-scanning direction. Accordingly, the row pitch of the scanning tracks (scanning lines) of the exposure beams 53 from the micromirrors is narrower than the pitch of the scanning lines would be if the exposure area 168 were not inclined. Thus, the image can be recorded with higher resolution.

Hence, as the photosensitive material 150 is moved together with the stage 152 at the constant speed, the photosensitive material 150 is scanned in a direction opposite to the stage movement direction by the scanner 162, and the strip-form exposed regions 170 are formed at the respective exposure heads 166.

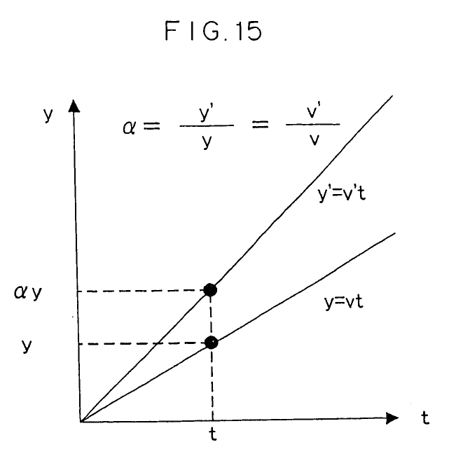

At this time, in the present embodiment, a scale factor of the image in the scanning direction can be set to a desired scale by altering the movement speed of the 152 (the scanning speed). Specifically, as shown in the graph of FIG. 15, if a scanning speed before alteration is v and a scanning speed after alteration is v′ (=αv), imaging positions when a duration t has passed are, respectively:

y=vt (equation 2)

y=v′t (equation 3)

Thus:

y′/y=v′t/vt=v′/v (equation 4)

Therefore, a scale factor conversion in the scanning direction by a ratio α relative to a scale factor before alteration can be carried out by scanning with the scanning speed altered to v′.

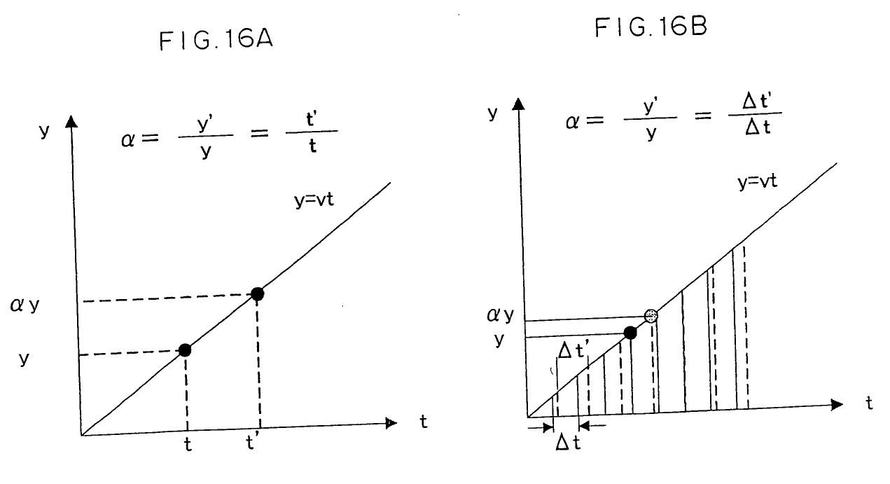

Accordingly, in the present embodiment, it is possible to convert a scale factor in the scanning direction to a desired scale for the whole image. Further, scale factor differences in the scanning direction between the plurality of exposure heads 166 that structure the exposure head unit 165 can be corrected for by altering pixel update timings for each of the exposure heads 166. Specifically, as shown in FIG. 16A, if an update interval before an update timing alteration is Δt and an update interval after this alteration is Δt′ (=αΔt), respective scanning positions y and y′ at an n-th update time (n being a natural number) are:

y=vΔt×n (equation 5)

y′=vΔt′×n (equation 6)

Thus:

y′/y=(vΔt′×n)/(vΔt×n)=Δt′/Δt (equation 7)

Therefore, a scale factor conversion in the scanning direction by a ratio α relative to a scale factor before alteration can be carried out for individual exposure heads 166 by scaling the pixel update timing by α. Thus, scaling differences between the exposure heads 166 can be corrected for.

Now, if a value of the above-mentioned α is considered as being substantially a conversion scale factor in the scanning direction, then, with regard to implementing image recording in practice, it is preferable if a range of numerical values thereof is set to not less than 0.95 and not more than 1.05. However, values of a are not limited thus.

It is also possible to convert the scaling in the scanning direction for the whole of an image by implementing an alteration of the data update timing of the DMD 50 for all of the exposure heads 166 together.

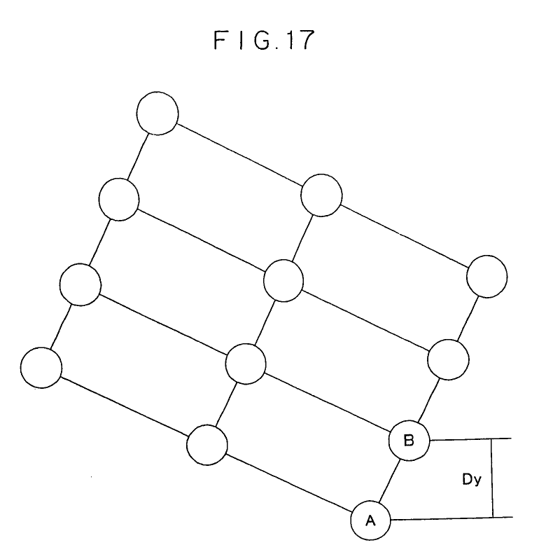

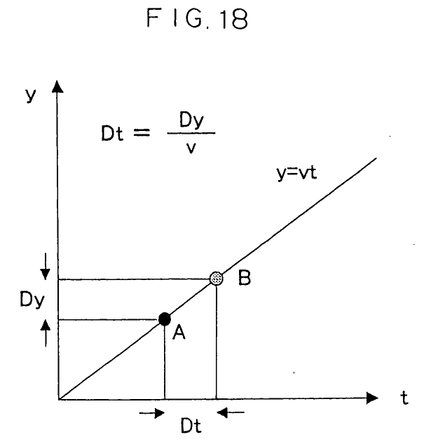

FIG. 17, similarly to FIG. 9, shows images of exposure beams from the DMD 50 (pixels), of which four in the scanning direction and three in the head alignment direction are taken. Here, an exposure beam image 53A and an exposure beam image 53B are separated by a distance Dy in the scanning direction. Therefore, as shown in FIG. 18, it is necessary for imaging of the exposure beam image 53B to be carried out with a timing which is retarded by Dt=Dy/v relative to the exposure beam image 53A.

Ordinarily, at imaging heads such as the exposure heads 166 of the present embodiment or the like, there are many cases in which an assignable data update reference interval Δt is specified individually for each head, and pluralities of image pixels (the DMD 50 in the present embodiment) are updated synchronously therewith. In this case, the exposure beam image 53B is rendered with a timing which is retarded relative to the exposure beam image 53A by a duration:

int[Dy/vΔt+0.5]Δt (equation 8)

Here, “int[ ]” is a function which converts the value inside the brackets to an integer value by rounding down.

Accordingly, when scanning of the photosensitive material 150 by the scanner 162 has been completed and the trailing end of the photosensitive material 150 has been detected by the detection sensors 164, the stage 152 is returned along the guides 158 by the unillustrated driving apparatus to a start point at an upstream-most side of the gate 160, and is again moved along the guides 158, at the constant speed, from the upstream side to the downstream side of the gate 160.

Now, in a structure that carries out multiple exposure such as the present embodiment, a wider area of the DMD 50 can be illuminated in comparison to a structure which does not perform multiple exposure. Therefore, it is possible to make a focusing depth of the exposure beams 53 longer. For example, if the DMD 50 that was employed had a pitch of 15 mm and a length L=20 rows, a length of the DMD 50 corresponding to a single division region 178D (a length in the column direction) would be 15 mm×20=0.3 mm. To irradiate the light at this narrow area, it would be necessary to make a spreading angle of the flux of the laser light that illuminates the DMD 50 larger by using, for example, the lens system 67 shown in FIGS. 5A and 5B. Therefore, the focusing depth of the exposure beams 53 would be shorter. In contrast, in the case in which a wider region of the DMD 50 is illuminated, the spreading angle of the flux of the laser light that is irradiated at the DMD 50 is smaller. Therefore, the focusing depth of the exposure beams 53 is longer.

In the above, an exposure head which is equipped with a DMD as a spatial light modulation element has been described. However, besides such reflection-type spatial light modulation elements, transmission-type spatial light modulation elements (such as LCDs) may be employed. For example, MEMS (microelectro-mechanical systems) type spatial modulation elements (SLM: spatial light modulator); elements which modulate transmitted light by electro-optical effects, such as optical elements (PLZT elements), liquid crystal shutter arrays such as liquid crystal shutters (FLC) and the like, and the like; and spatial light modulation elements other than MEMS types may be utilized. Here, MEMS is a general term for microsystems in which micro-size sensors, actuators and control circuits are integrated by micro-machining technology based on IC fabrication processes. MEMS type spatial light modulation elements means spatial light modulation elements which are driven by electromechanical operations by utilization of electrostatic forces. Further, a spatial light modulation element which is structured to be two-dimensional by lining up a plurality of grating light valves (GLV) may be utilized. In structures which employ these reflection-type spatial light modulation elements (such as GLVs), transmission-type spatial light modulation elements (such as LCDs) and the like, besides the lasers discussed above, lamps and the like may be employed as light sources.

For the embodiment described above, an example in which the fiber array light source that is utilized is equipped with a plurality of multiplex laser light sources has been described. However, the laser apparatus is not limited to a fiber array light source in which multiplexed laser light sources are arranged. For example, a fiber array light source may be utilized in which fiber light sources which are each equipped with a single optical fiber, which emits laser light inputted from a single semiconductor laser having one light emission point, are arrayed.

A light source in which a plurality of light emission points are two-dimensionally arranged (for example, a laser diode array, an organic electroluminescent array or the like) may be employed. With a structure which employs such a light source, each light emission point corresponds to a pixel. Hence, it is possible to omit the spatial light modulation devices discussed above.

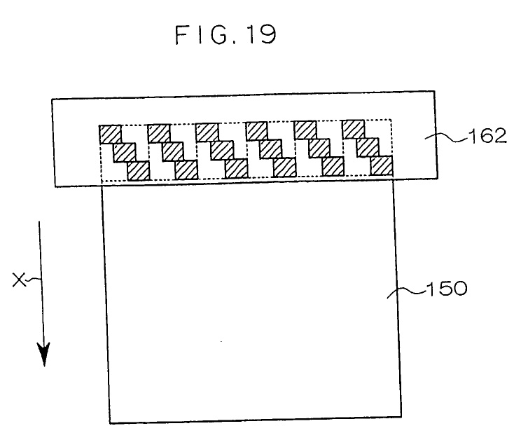

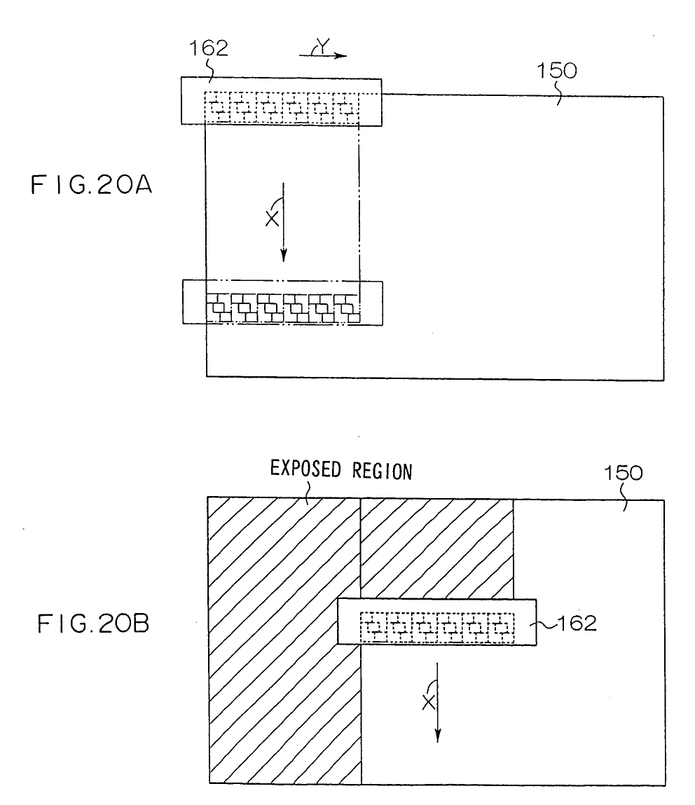

For the embodiment described above, an example has been described in which the whole surface of the photosensitive material 150 is exposed by a single cycle of scanning in a direction X by the scanner 162, as shown in FIG. 19. Alternatively, as shown in FIGS. 20A and 20B, a cycle of scanning and movement may be repeated such that, after the photosensitive material 150 has been scanned in the direction X by the scanner 162, the scanner 162 is moved one step in a direction Y and scanning is again carried out in the direction X. Thus, the whole surface of the photosensitive material 150 can be exposed by a plurality of cycles.

In the embodiment described above, a so-called flatbed-type exposure device has been offered as an example. However, an exposure device of the present invention could be a so-called outer drum-type exposure device, which includes a drum around which photosensitive material is wound.

The exposure apparatus described above may be suitably utilized for application to, for example, exposure of a dry film resist (DFR) in a process for fabricating a printed wiring board (PWB), formation of a color filter in a process for fabricating a liquid crystal display (LCD), exposure of a DFR in a process for fabricating a TFT, exposure of a DFR in a process for fabricating a plasma display panel (PDP), and the like.

With the exposure apparatus described above, either of photon mode photosensitive materials, which are directly recorded with information by exposure, and heat mode photosensitive materials, in which heat is generated by exposure and information is recorded thereby, may be employed. In cases in which photon mode photosensitive materials are employed, GaN-based semiconductor lasers, wavelength-conversion solid state lasers or the like are employed at the laser apparatus, and in cases in which heat mode photosensitive materials are employed, AlGaAs-based semiconductor lasers (infrared lasers) or solid state lasers are employed at the laser apparatus.

Further, the present invention is not limited to exposure devices, and can be employed with similar structures at, for example, inkjet recording heads. Specifically, at an ordinary inkjet recording head, nozzles which eject ink droplets are formed in a nozzle face opposing a recording medium (for example, recording paper, an overhead projector sheet or the like). Among inkjet recording heads, there are inkjet recording heads in which these nozzles are plurally disposed in a checkerboard pattern, are inclined relative to a scanning direction of the head itself, and are capable of recording images with high resolution. With inkjet recording heads which employ such two-dimensional arrangements, even if there is a scale factor difference in the scanning direction between the inkjet recording heads, this can be corrected for.

What is claimed is:

1. An imaging head unit comprising a plurality of imaging heads arranged along a direction intersecting a predetermined scanning direction, the imaging heads moving relative to a respective imaging surface in the scanning direction along the imaging surface,
wherein pixel update timings of the imaging heads are alterable in at least the scanning direction for individual the imaging heads.

2. The imaging head unit of claim 1, wherein each imaging head comprises a plurality of imaging elements and the alteration of a pixel update timing is implemented by altering an imaging timing by a duration which is determined by a ratio between a spacing error of an imaging element in the scanning direction and a scanning speed.

3. The imaging head unit of claim 2, wherein the alteration of the imaging timing is implemented by retarding the imaging timing.

4. The imaging head unit of claim 2, wherein the alteration of the imaging timing is implemented by advancing the imaging timing.

5. The imaging head unit of claim 1, wherein each imaging head comprises a plurality of imaging elements which are two-dimensionally arranged in a plane which is substantially parallel to the imaging surface, and the imaging head is rotatable about a line perpendicular to the imaging surface.

6. The imaging head unit of claim 1, wherein a scanning speed in the scanning direction is alterable.

7. The imaging head unit of claim 1, wherein each imaging head comprises a modulated light irradiation apparatus which irradiates light, which is modulated at each of pixels in accordance with image information, at an exposure surface which includes the scanning surface.

8. The imaging head unit of claim 7, wherein the modulated light irradiation apparatus comprises:
a laser device which irradiates laser light;
a spatial light modulation element at which numerous imaging element portions, which respectively alter light modulation states in accordance with control signals, are arranged in a two-dimensional arrangement, the spatial light modulation element modulating the laser light irradiated from the laser device; and
a control section which controls the imaging element portions by the control signals, which are generated in accordance with the image information.

9. The imaging head unit of claim 8, wherein the spatial light modulation element comprises a micromirror device which includes numerous micromirrors arranged in a two-dimensional arrangement, angles of reflection surfaces of which micromirrors are respectively alterable in accordance with the control signals.

10. The imaging head unit of claim 8, wherein the spatial light modulation element comprises a liquid crystal shutter array which includes numerous liquid crystal cells arranged in a two-dimensional arrangement, which are respectively capable of blocking transmitted light in accordance with the control signals.

11. An imaging device comprising:
an imaging head unit including a plurality of imaging heads arranged along a direction intersecting a predetermined scanning direction, the imaging heads moving relative to a respective imaging surface in the scanning direction along the imaging surface, and pixel update timings of the imaging heads being alterable in at least the scanning direction for individual the imaging heads; and
a movement apparatus which relatively moves the imaging head unit in the predetermined scanning direction.

12. An imaging method which employs the imaging head unit of claim 1, comprising:
relatively moving an imaging unit, which includes the imaging head unit, along the imaging surface in the predetermined scanning direction for imaging;
altering pixel update timings for individual the imaging heads in accordance with a scale factor difference; and
implementing a conversion of an imaging scale factor in at least the scanning direction.

13. An imaging method which employs an imaging head unit, comprising the steps of:
relatively moving an imaging unit, which includes the imaging head unit, along the imaging surface in the predetermined scanning direction for imaging;
altering pixel update timings for individual the imaging heads in accordance with a scale factor difference; and
implementing a conversion of an imaging scale factor in at least the scanning direction.
